(19) United States
(12) Patent Application Publication
(10) Pub. No.: US 2012/0280919 A1
(43) Pub. Date: Nov. 8, 2012

(54) Electronic Paper Display Apparatus with Touch Control Function

(75) Inventor: Shih-Chang CHU, HSINCHU (TW)

(73) Assignee: E INK HOLDINGS INC., HSINCHU (TW)

(21) Appl. No.: 13/239,394

(22) Filed: Sep. 22, 2011

(30) Foreign Application Priority Data
May 2, 2011 (TW) 100115369

(51) Int. Cl. G06F 3/041

(52) U.S. Cl. 345/173

(57) ABSTRACT

An electronic paper display apparatus is disclosed. The electronic paper display apparatus includes an electronic paper device and a color filter. The color filter is disposed on the electronic paper device. The color filter includes a filter substrate, a color resist layer and a sensing electrode of a touch panel. The sensing electrode and the color resist layer are formed on different surfaces of the filter substrate, or on the same surface of the filter substrate.

### CROSS-REFERENCE TO RELATED APPLICATION

This application claims the priority benefit of Taiwan application serial no. 100115369, filed on May 2, 2011. All disclosure of the Taiwan application is incorporated herein by reference

### BACKGROUND

1. Field of Invention

The present invention relates to an electronic paper display apparatus. More particularly, the present invention relates to an electronic paper display apparatus with a touch control function.

2. Description of Related Art

With improvements in techniques for manufacture and design, many new display apparatuses have been developed. The electronic paper display apparatus presents many advantages including low energy consumption, long life, and small size.

The electronic paper display apparatus was developed in the 1970s. One of the major characteristics of this display apparatus is its incorporation of electrically charged micro-spheres, half of which are painted white and the other half painted black. When an electric field is adjusted, the sphere will rotate top to bottom and hence display a different color. In the second generation of electronic paper display apparatuses developed in the 1990s, mini capsules have replaced the micro-spheres. Colored oil and charged white particles fill the mini capsules. The white particles can move to the top or sink to the bottom under a controlled electric field. When the white particles rise to the top (move closer to the reader), a white color is displayed. On the other hand, when the white particles sink to the bottom (away from the reader), the color of the oil is displayed.

Typically, physical buttons disposed on the shell of an electronic paper apparatus are used to start or stop functions provided by the electronic paper device. However, when the electronic paper device provides more and more functions, an increasing number of physical buttons are used to control these functions. Such an operational structure will occupy a lot of the area of the shell to make it difficult to reduce the size of the electronic paper apparatus.

Therefore, a new operational structure is required.

### SUMMARY

This present invention provides an electronic paper display apparatus with a touch control function. Virtual buttons are used to control the electronic paper display apparatus.

This present invention provides an electronic paper display apparatus. The electronic paper display apparatus includes an electronic paper device and a color filter disposed on the electronic paper device. The color filter has a touch panel sensing electrode.

In an embodiment, the touch panel is a capacitive sensing touch panel, a resistive sensing touch panel, an ultrasonic sensing touch panel, an electromagnetic sensing touch panel or a dual mode (capacitive and resistive) sensing touch panel.

In an embodiment, the color filter includes a filter substrate and a color resist layer formed on the filter substrate.

In an embodiment, the color filter includes a filter substrate and a color resist layer formed on the filter substrate. The touch panel electrode is disposed on the filter substrate without the color resist layer.

In an embodiment, the color filter includes a filter substrate. The touch panel electrode is formed on the filter substrate. The color resist layer is formed on the touch panel electrode.

In an embodiment, the color filter includes a filter substrate. The color resist layer is formed on the filter substrate. The touch panel electrode is formed on the color resist layer.

In an embodiment, a protection film is formed on the color filter.

In an embodiment, an optical adhesive is used to adhere the color filter to the electronic paper device.

In an embodiment, the material for forming the touch panel sensing electrode is indium zinc oxide (IZO) or indium tin oxide (ITO).

Accordingly, a touch panel electrode is integrated into an electronic paper display apparatus. Therefore, a user can directly touch the screen to control this electronic paper display apparatus.

### BRIEF DESCRIPTION OF THE DRAWINGS

The invention can be more fully understood by reading the following detailed description of the embodiments, with reference made to the accompanying drawings as follows:

FIG. 1 is a cross-sectional view of an electronic paper display apparatus.

FIG. 2 is a cross-sectional view of a color electronic paper display apparatus.

FIG. 3 is a schematic diagram of a color filter.

FIG. 4 is a cross-sectional view of an electronic paper display apparatus with a capacitive sensing touch panel according to an embodiment.

FIG. 5 is a cross-sectional view of an electronic paper display apparatus with a capacitive sensing touch panel according to another embodiment.

FIG. 6 is a cross-sectional view of an electronic paper display apparatus with a capacitive sensing touch panel according to another embodiment.

### DETAILED DESCRIPTION

Touch panels have replaced mouse devices and keyboards for use as input devices in many electronic products. A characteristic of the present invention is to integrate a touch panel into an electronic paper display apparatus.

Depending on the sensing method used, a touch panel can be classified into a capacitive sensing touch panel, a resistive sensing touch panel, an ultrasonic sensing touch panel, an electromagnetic sensing touch panel or a dual mode (capacitive and resistive) sensing touch panel. There are two types of capacitive sensing touch panel, one is surface capacitive touch, and the other is projected capacitive touch. A surface capacitive sensing touch panel includes an insulator such as glass, coated with a transparent conductor such as indium tin oxide (ITO). When a conductor, such as a human finger, touches the screen, a capacitor is dynamically formed. A capacitive sensing controller can determine the location of the touch from the change in the capacitance as measured from the four corners of the panel. The location is then sent to a device controller for processing. A projected capacitive touch panel works on the principle of conventional capacitive touch panels with the addition of two sensing arrays (X and Y) on two different layers that are perpendicular to each other along with a drive line. As X and Y arrays exist on different layers, the point where the two intercept becomes a capacitive node. When electrical currents run along one of the arrays through the drive line, the other array and the circuitry that detects change in capacitive values becomes connected. During actual operation, the controller sends electrical currents to the drive lines on different layers to create a specific electrical field with the nodes. When the user places his finger or uses a touch medium close to the touch screen, the controller immediately picks up the change in capacitive value between the nodes and drive lines to pinpoint the exact location of the touch event. Since the sensing arrays on the panel form a 3D electrical field that is independent to the surface capacitors, the touch event registers even when no physical contact with the touch screen is made. In other words, projected capacitive touch screens feature Z-axis recognition.

In the following example, the electronic paper display apparatus uses a capacitive sensing touch panel to sense touching locations. However, in another embodiment, the electronic paper display apparatus can use different types of touch panels to sense touching locations.

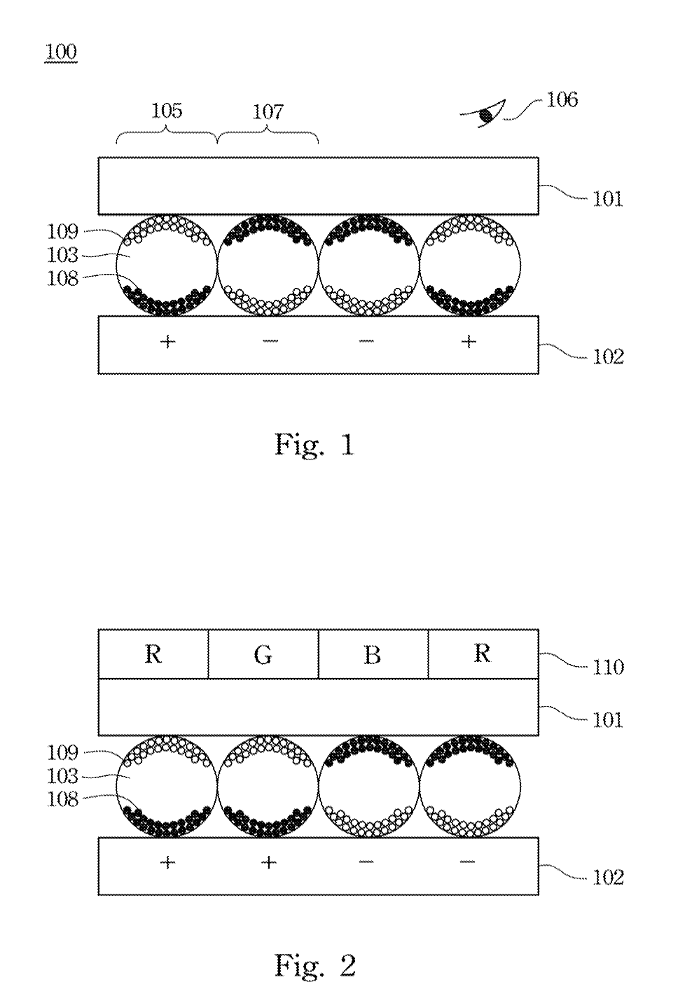

FIG. 1 is a cross-sectional view of an electronic paper display apparatus. The electronic paper display apparatus 100 includes two glass substrates 101 and 102 and an electronic ink layer 103 located between the two glass substrates 101 and 102. A common electrode is formed over the glass substrate 101. A plurality of electrodes are formed in the glass substrate 102. The glass substrates 101 and 102 can be replaced by plastic substrates. The electronic ink layer 103 includes a plurality of microcapsules, each with a diameter of about 50 micrometers to 70 micrometers. Each microcapsule includes black particles 108 and white particles 109. When the electrodes in the glass substrate 102 are charged, the charged electrodes can move up or down the black particles 108 and white particles 109 to display a black-white image on the visual side 106. For example, the black particles 108 are negatively charged and the white particles 109 are positively charged. When an electrode in the glass substrate 102 is charged to form a positive electrode, the negatively charged black particles 108 are attracted and the positively charged white particles 109 are repulsed. That is, the white particles 109 are arranged on the visual side 106 to make the pixel 105 display a white color. When an electrode in the glass substrate 102 is charged to form a negative electrode, the positively charged white particles 109 are attracted and the negatively charged black particles 108 are repulsed. That is, the black particles 108 are arranged on the visual side 106 to make the pixel 107 display a black color.

FIG. 2 is a cross-sectional view of a color electronic paper display apparatus. For displaying a color image, a color filter 110 is formed on the glass substrate 101. By controlling the intensity of light passing through three primary colors of red, green and blue (RGB), a full-color image can be obtained.

FIG. 3 is a schematic diagram of a color filter. The color filter 110 includes a filter substrate 114 and a color resist layer 112 formed on the filter substrate 114. Three primary colors, namely, red, green and blue (RGB), are represented in each pixel. The display color of a pixel can be modified by controlling the intensity of light passing through the three primary colors of red, green and blue (RGB). For example, a yellow color is formed by mixing a red color and a green color. Therefore, when a pixel needs to show a yellow color, electrodes in the glass substrate 102 corresponding to the red color resist and green color resist are charged to form a positive electrode, such that the negatively charged black particles 108 are attracted and the positively charged white particles 109 are repulsed to cause the white particles 109 to be located on the visual side 106 reflect red color light and green color light. The electrodes in the glass substrate is 102 corresponding to the blue color resist are charged to form a negative electrode, such that the positively charged white particles 109 are attracted and the negatively charged black particles 108 are repulsed to cause the black particles 108 to be located on the visual side 106 absorb blue color light. That is, only the red color light and the green color light are reflected for this pixel. Therefore, a yellow color is shown by this pixel.

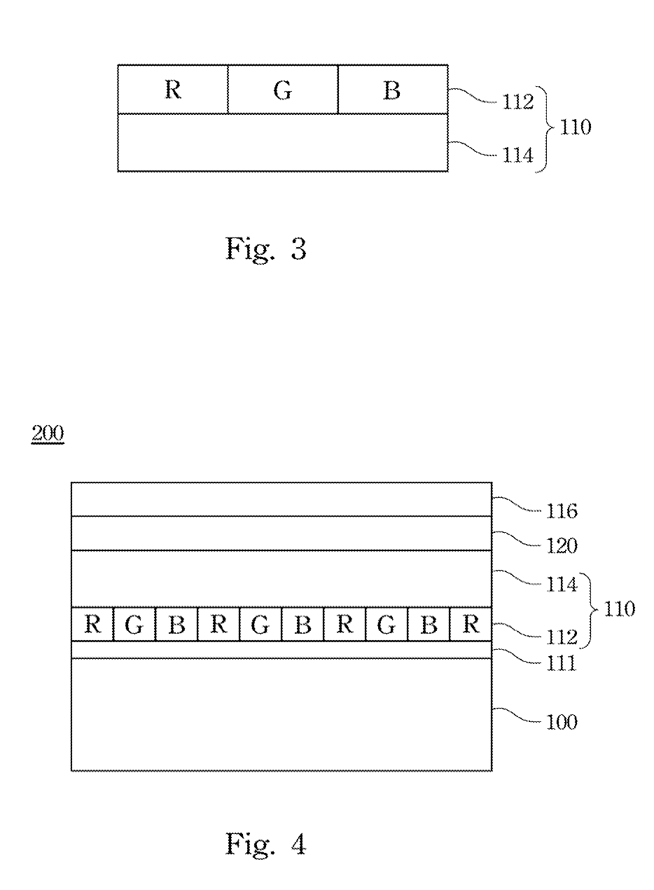

FIG. 4 is a cross-sectional view of an electronic paper display apparatus with a capacitive sensing touch panel according to an embodiment. The electronic paper display apparatus 200 includes an electronic paper device 100, a color filter 110 and a protection film 116. The sensing electrode 120 of a capacitive sensing touch panel is formed on the color filter 110. In particular, the sensing electrode 120 is formed on a surface of the filter substrate 114 and the color resist layer 112 is formed on another surface of the filter substrate 114. The material for forming the sensing electrode 120 is indium zinc oxide (120), indium tin oxide (ITO) or another transparent metal. The protection film 116 is formed on the sensing electrode 120 and functions to prevent moisture from entering into the electronic paper display apparatus 200. The protection film 116 has an anti-glare and/or anti-reflection function. An optical adhesive is used to adhere the color filter 110 with sensing electrode 120 to the electronic paper device 100.

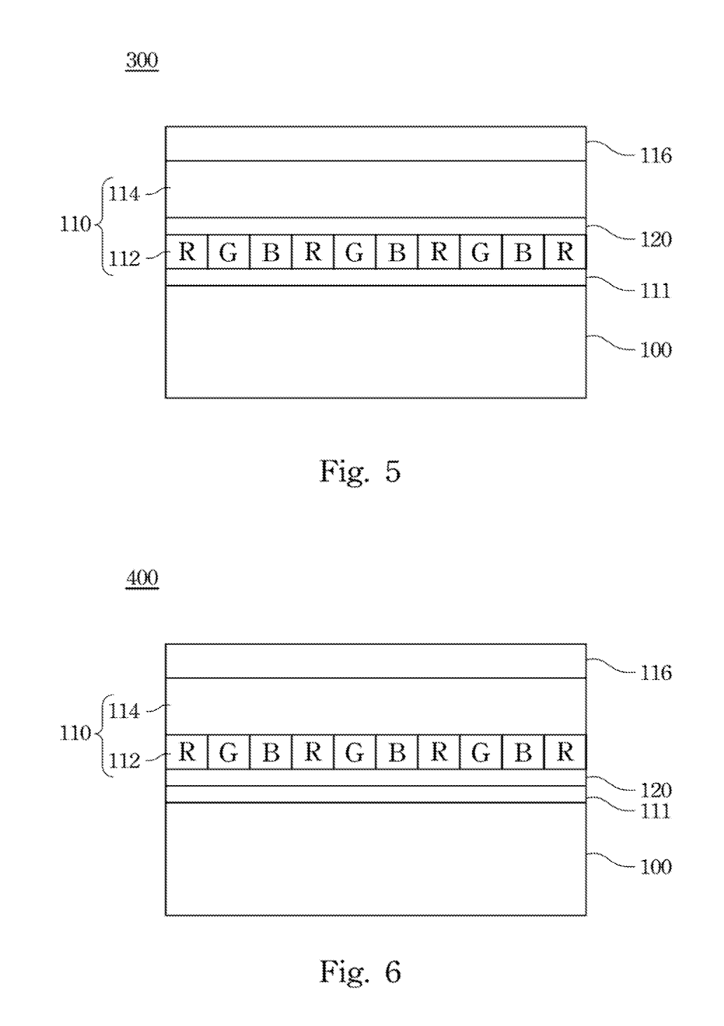

FIG. 5 is a cross-sectional view of an electronic paper display apparatus with a capacitive sensing touch panel according to another embodiment. The electronic paper display apparatus 300 includes an electronic paper device 100, a color filter 110 and a protection film 116. The sensing electrode 120 of a capacitive sensing touch panel is formed on the color filter 110. In particular, the sensing electrode 120 is formed on the filter substrate 114 and the color resist layer 112 is formed on the sensing electrode 120. That is, the sensing electrode 120 is formed between the filter substrate 114 and the color resist layer 112. Similarly, an optical adhesive is used to adhere the color filter 110 with sensing electrode 120 to the electronic paper device 100.

FIG. 6 is a cross-sectional view of an electronic paper display apparatus with a capacitive sensing touch panel according to another embodiment. The electronic paper display apparatus 400 includes an electronic paper device 100, a color filter 110 and a protection film 116. The sensing electrode 120 of a capacitive sensing touch panel is formed on the color filter 110. In particular, the color resist layer 112 is formed on the filter substrate 114 and the sensing electrode 120 is formed on the color resist layer 112. That is, the color resist layer 112 is formed between the filter substrate 114 and the sensing electrode 120. Similarly, an optical adhesive is used to adhere the color filter 110 with sensing electrode 120 to the electronic paper device 100.

Accordingly, a touch panel sensing electrode is integrated into an electronic paper display apparatus. Therefore, a user can directly touch the screen to control operation of this electronic paper display apparatus. Moreover, the sensing electrode is formed on a color filter. The color filter can be adhered to the electronic paper device using an optical adhesive. Therefore, it is easy to produce an electronic paper display apparatus with a touch control function.

Although the present invention has been described in considerable detail with reference to certain embodiments thereof, other embodiments are possible. Therefore, it will be apparent to those skilled in the art that various modifications and variations can be made to the structure of the present invention without Is departing from the scope or spirit of the invention. In view of the foregoing, it is intended that the present invention cover modifications and variations of this invention provided they fall within the scope of the following claims.

What is claimed is:

1. An electronic paper display apparatus, comprising:
an electronic paper device; and
a color filter disposed on the electronic paper device, wherein the color filter has a sensing electrode of a touch panel.

2. The electronic paper display apparatus of claim 1, wherein the touch panel is a capacitive sensing touch panel, a resistive sensing touch panel, an ultrasonic sensing touch panel, an electromagnetic sensing touch panel or a dual mode sensing touch panel.

3. The electronic paper display apparatus of claim 1, wherein the color filter includes a filter substrate and a color resist layer formed on the filter substrate.

4. The electronic paper display apparatus of claim 3, wherein the filter substrate further includes a first surface and a second surface, wherein the color resist layer is formed on the first surface and the sensing electrode is formed on the second surface.

5. The electronic paper display apparatus of claim 3, wherein the sensing electrode is formed on the filter substrate and the color resist layer is formed on the sensing electrode.

6. The electronic paper display apparatus of claim 3, wherein the color resist layer is formed on the filter substrate and the sensing electrode is formed on the color resist layer.

7. The electronic paper display apparatus of claim 1, further comprising a protection film formed on the color filter.

8. The electronic paper display apparatus of claim 7, wherein the protection film comprises at least one of an anti-glare film and an anti-reflection film.

9. The electronic paper display apparatus of claim 1, wherein an optical adhesive is used to adhere the color filter to the electronic paper device.

10. The electronic paper display apparatus of claim 1, wherein the material for forming the sensing electrode is indium zinc oxide (IZO) or indium tin oxide (ITO)
